(19) United States
(12) Patent Application Publication
(10) Pub. No.: US 2019/0344698 A1
(43) Pub. Date: Nov. 14, 2019

(54) Unfolding Tailgate Ramp

(71) Applicants: Matthew Quentin Estes, Front Royal, VA (US); Daniel John Salmon, JR., Centreville, VA (US)

(72) Inventors: Matthew Quentin Estes, Front Royal, VA (US); Daniel John Salmon, JR., Centreville, VA (US)

(21) Appl. No.: 15/976,697

(22) Filed: May 10, 2018

(51) Int. Cl. B60P 1/43; B62D 33/027; B62D 33/03

(52) U.S. Cl. CPC B60P 1/435; B62D 33/03; B62D 33/0273

(57) ABSTRACT

Disclosed is a spring-biased, folding ramp that is configured for connection to the rear of a pickup truck. The ramp has an upper section and a lower section that unfold to form a continuous ramp from truck to ground. Springs connecting each section are stretched when the ramp is unfolded and provide a helpful assist when re-folding the ramp back up onto the truck.

### CROSS-REFERENCE TO RELATED APPLICATION

This application is related to U.S. provisional patent application Ser. No. 62/504,099 the disclosure of which is hereby incorporated by reference.

### FIELD OF THE INVENTION

The invention relates to a hinged, utility ramp that can be attached to a truck and unfolded for loading and unloading of wheeled yard equipment.

### BRIEF DESCRIPTION OF THE DRAWINGS

FIG. 1 is an illustration of an unfolding ramp according to the invention that is attached to the rear of a truck.

FIG. 2 is a rear view of the folded gate of FIG. 1.

FIG. 3 shows an unfolded gate according to the invention.

FIG. 4 is another view of the unfolded gate according to FIG. 3.

FIG. 5 is a view of the bottom of the unfolded gate showing the hinge and spring connections.

FIG. 6 is a diagram showing the unfolding steps of the upper and lower frames.

### SUMMARY OF THE INVENTION

The invention relates to a hinged, spring-assisted, load ramp that replaces a standard pickup truck tailgate and is configured to be both opened and closed by a single operator. In a preferred embodiment, the ramp is made in two sections that can be unfolded and extended from its mounted position at the back of a pickup truck to allow fast loading and unloading of equipment in the bed of the truck. The ramp is rigid when unfolded and provides a sloped ramp surface that allows hand trucks, rolling vehicles, and similar equipment to be loaded/unloaded quickly. The use of springs helps to bias the ramp components so as to reduce the weight encountered by the operator when extending or folding the ramp.

The frame is made of angle steel welded into two rectangular shapes, an upper frame attached to the truck with a hinged connection and a lower frame that extends to the ground when fully extended. The upper and lower frames are connected to each other in a hinged connection that allows a pivoting connection. The hinged connection can come from commercial steel hinges welded to the frame edges or the hinged connection is made with a continuous hinge spanning substantially the entire width of the frames. Preferably, the frame connection hinges are welded to the upper and lower frames.

For extra support there are two pieces of angle steel welded at the frame edges of the lower rectangle and which extend past the ends of the rectangular frame so as to engage the lower edge of the frame that is attached to the truck. This connection acts as a stop on the rotation of the frames and forms a substantially straight ramp from truck gate to the ground.

Welded to the surface of the frame and its support are two sheets of raised expanded grid steel. The frame has an additional piece of angle steel welded on top of the raised expanded grid steel and to the side of the frame acting as a brace for support to alleviate stress to the hinges. At the base on each side of one half of the frame is a cut to size steel pipe, left side closed, right side semi-open, to attach at the bottom of the normal tailgate's pivot point at the back end of the truck's bed above the bumper.

What makes this design unique and patent worthy is the “fold-assist” feature. High tension springs connect the upper and lower frames that bias the frames in an upright, folded configuration and are under tension when the upper and lower frames are. The springs are anchored with half link chain welded to the inside of the frame. The spring is stretched to length prior to being anchored. The purpose of the spring is to provide a fold assist that as well creates a minor lift assist due to a majority of the weight being supported at the bumper and tailgate pivot point.

With our unique idea for a fold assist, there is less stress to the frame and hinges while unfolding allowing for a simpler yet unique and lighter design while staying versatile. It allows where no other tailgate ramp can, for one man operation with a functional time of five to ten seconds. It can be completely unlatched and unfolded ready for use in ten seconds or less, and is even quicker and easier to fold back up due to the positioning of the springs to help support the weight during the assisted fold “pulling the bottom half back up to the bumper” if you will.

Our preferred embodiment has a catch-and-latch system mounted on the truck on either side of the ramp. We have designs for an expandable stake pocket bracket catch and latch system that makes the promise of no permanent modification to the owner's truck while making the tailgate semi-permanent and completely removable at the owner's discretion.

Base Model

In the base model, the overall concept stays the same. The overall outside frame. More hinges may be used. The welding of the raised expanded grid steel stays the same. The additional piece of angle steel acting as a brace during the unfolding will be longer for more support. Instead of two pieces of angle steel for support in the frame there will be four for each half of the frame. The extra two will be welded together to create a T brace in the center of each rectangular piece. The other two will be spaced evenly between the center T brace and the outside frame. Instead of two springs there will be four for additional support for the additional weight for tailgates that are designed larger (for wider truck beds and trucks that rest higher off the ground). With the larger pieces comes more weight which will require two more springs.

Custom Model (Commercial Use)

In the commercial version of the ramp, the overall concept stays the same. The welding of the raised expanded grid steel stays the same. The additional piece of angle steel acting as a brace during the unfolding will be longer for more support. More hinges may be used. The outside frame will consist of square steel tube instead of angle steel. The center brace will be square steel tube as well. The secondary braces spaced between the center and outside frame will be spaced to the client's equipment needs (spaced based on equipment's wheel distance). Some designs may require for four T braces spaced to catch the outside of the wheels for heavier equipment while retaining the center square steel tube. Even with four high tension springs placed appropriately on the inside of the frame, two additional springs will be attached the same way to the backside of the back catch and to the top outside of the frame for additional weight support during the unfolding and folding of the tailgate.

Expandable Stake Pocket Bracket Catch and Latch System (Non-Permanent)

Using a stake pocket bracket as an expandable insert into the pickup truck bed's hole we will weld the angle steel to the front side as the catch mechanism for the tailgate, a second piece of angle steel will be welded to the backside going parallel to the top of the truck's bedside towards and above the tail-lights. Another piece of angle steel will be cut to size and welded into place to provide a surface for welding the lockable latch into place. This allows the entire design to be semi-permanent, completely removable with no permanent or lasting modification to the truck.

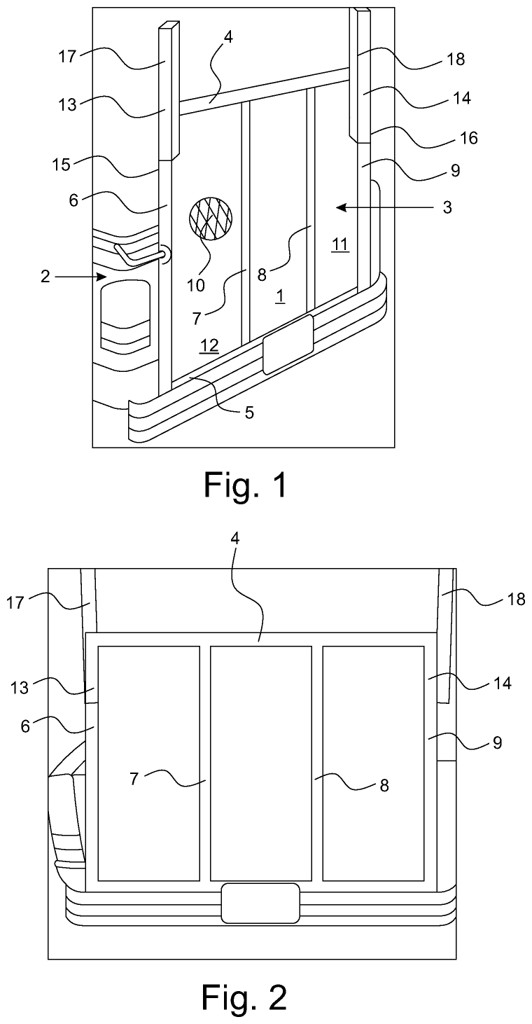

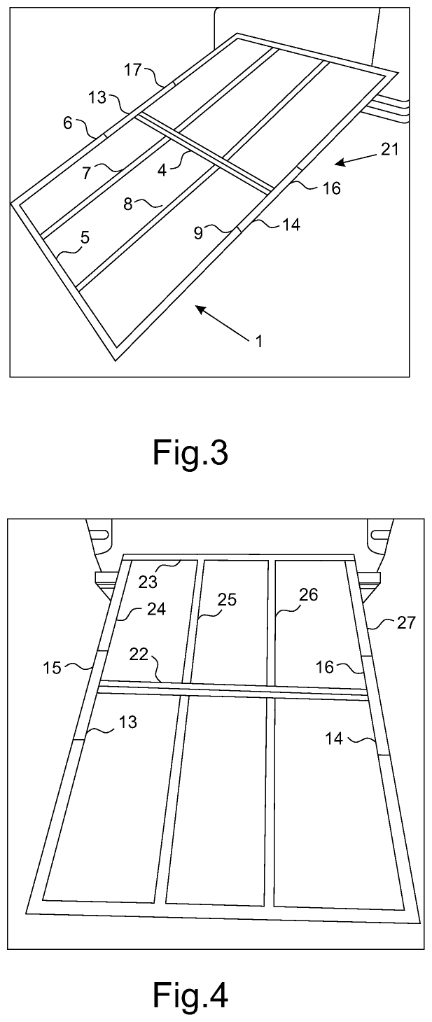

FIGS. 1 and 2 show folding ramp assembly 1 in a folded configuration behind truck 2. Lower rectangular section 3 is formed with horizontal bars 4, 5 and vertical bars 6, 7, 8, 9 that have all been welded together. Preferably, a durable, metal grating 10 covers the entirety of lower section 3 on the top surface 11 that will thereby form a durable ramp when unfolded. Extension arms 13, 14 are made from L-shaped stock and welded to the outside edges 15, 16 of the outermost vertical bars 6, 9, respectively, so that the upper portions 17, 18 that extend beyond horizontal bar 4 will engage the edges of the outer vertical bars 19, 20 in the upper ramp section 21 (see FIGS. 3 and 4). Horizontal rods 22, 23 and vertical rods 24, 25, 26, 27 are welded together like lower section 1 to form upper section 21.

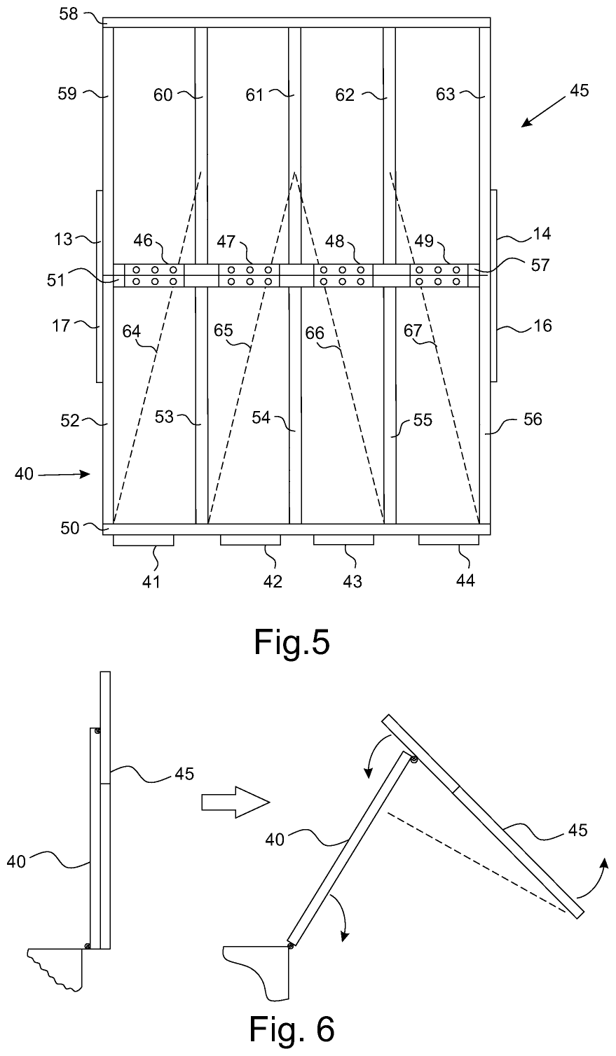

FIG. 5 is a bottom view of an embodiment made with an upper ramp section 40 that is attached to a truck (not shown) with one or more hinges, such as hinges 41, 42, 43, 44 and to lower ramp section 45 with hinges 46, 47, 48, 49. Upper ramp section 40 is made with horizontal bars 50, 51 and vertical bars 52, 53, 54, 55, 56. Lower ramp section 45 is made with horizontal bars 57, 58 that are welded to vertical bars 59, 60, 61, 62, 63.

Bias springs 64, 65, 66, 67 connect upper ramp section 40 to lower ramp section 45 via attachment to ring-shaped connectors attached on either section, e.g., between vertical bar 52 and vertical bar 60, vertical bar 53 to vertical bar 61, etc.

Our design allows for a lightweight tailgate ramp that is simple yet unique in design that can be operated in five to ten seconds by one person. Applications of the invention allow for the loading of gardening & landscaping supplies, fridges, washer/dryer units, deep freezers, etc., to be done as simply as pulling a dolly up a ramp. As well the capability to load motorcycles, dirt bikes, all-terrain vehicles (atvs), and riding mowers onto the bed of a pickup truck becomes much more viable and safe. The commercial applications for this ramp are near endless with a potential for an increased profit margin if used right. With the quick ease of use, the invention provides an increase in productivity for a landscaping company as opposed to using a trailer setup or manually putting a ramp into place to remove heavy mowing equipment from the truck. Overall it makes all aspects of hauling equipment, merchandise, etc., easier and in many cases completely negates the need to own a hitch trailer at all.

1. A spring-biased, unfolding ramp assembly that comprises:
a. an upper ramp section having one or more first set of hinges suitable for connection at a first upper section end to a pickup truck and one or more second set of hinges suitable for connection at a second upper section end to a lower ramp section;
b. a lower ramp section connected at a first lower section end to said second upper section end by said one or more second set of hinges, said lower ramp section having L-shaped arm extensions on either external side that extend beyond said lower ramp section and into engagement with corresponding external sides of said upper ramp section when said lower ramp section is unfolded to form a continuous ramp from said pickup truck to ground level; and
c. one or more springs that connect between said lower ramp section and said upper ramp section, said springs being stretched with the upper ramp section and the lower ramp section are unfolded to form a ramp and contracted with the upper ramp section and the lower ramp section are folded together.

2. A ramp according to claim 1 wherein a heavy metal grating covers substantially the entirety of an upper surface of the lower ramp section and the upper ramp section.
